(19) United States
(12) Patent Application Publication
(10) Pub. No.: US 2006/0000493 A1
(43) Pub. Date: Jan. 5, 2006

(54) Chemical-mechanical post-etch removal of photoresist in polymer memory fabrication

(76) Inventors: Richard M. Steger, Beaverton, OR (US); Ebrahim Andideh, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/882,423

(22) Filed: Jun. 30, 2004

(51) Int. Cl. B08B 7/00

(52) U.S. Cl. 134/33; 134/34

(57) ABSTRACT

An embodiment of the invention is a method of removing photoresist. More specifically, an embodiment is a method of removing photoresist utilized to pattern the top electrode metal layer in a polymer memory device substantially without damaging the underlying polymer or top electrode metal by utilizing a high pressure photoresist solvent spray.

### FIELD

Embodiments of the invention relate to semiconductor processing techniques, and specifically to photoresist removal techniques.

### BACKGROUND

Memory manufacturers are currently researching and developing the next generation of memory devices. One such development includes technology designed to replace current Flash non-volatile memory technology. Important elements of a Flash successor include compactness, low price, low voltage operation, non-volatility, high density, fast read and write cycles, and long life.

Current Flash technology is predicted to survive into 90 nanometer and 65 nanometer process generations. This survival is in part based on, for example, exotic storage dielectric material, cobalt and nickel source and drain regions, copper and low dielectric constant materials for the interconnect levels, and high dielectric constant materials for transistor gate dielectrics. However, there will thereafter exist a need for new memory materials and technology, particularly for non-volatile memory.

Ferroelectric memory is one such technology aimed to replace Flash memory. A ferroelectric memory device combines the non-volatility of Flash memory with improved read and write speeds. Simply stated, ferroelectric memory devices rely on the use of ferroelectric materials that can be spontaneously polarized by an applied voltage or electric field and that maintain the polarization after the voltage or field has been removed. As such, a ferroelectric memory device can be programmed with a binary “1” or “0” depending on the orientation of the polarization. The state of the memory device can then be detected during a read cycle.

Two crystalline materials have emerged as promising films utilized in a ferroelectric memory scheme, namely lead zirconium titanate (“PZT”) and strontium bismuth tantalite (“SBT”). However, while the materials exhibit appropriate ferromagnetic properties, each is nevertheless expensive to integrate into an existing CMOS process.

More recent developments include the use of polymers that exhibit ferroelectric properties. The creation of polymer ferroelectric memory utilizes polymer chains with net dipole moments. Data is stored by changing the polarization of the polymer chain between metal lines that sandwich the layer comprised of the ferroelectric polymer chain. Further, the layers can be stacked (e.g., metal word line, ferroelectric polymer, metal bit line, ferroelectric polymer, metal word line, etc.) to improve memory element density. The polymer ferroelectric memory devices exhibit microsecond initial read speeds coupled with write speeds comparable to Flash.

### BRIEF DESCRIPTION OF THE DRAWINGS

FIG. 1: illustration of a ferroelectric beta phase polyvinylidene fluoride (PVDF) molecule chain

FIG. 2: illustration of a top view of a polymer ferroelectric memory device

FIG. 3: illustration of a substrate cross section of a polymer ferroelectric memory device after the top electrode metal has been blanket deposited

FIG. 4: illustration of a substrate cross section of a polymer ferroelectric memory device after the photoresist has been deposited and patterned

FIG. 5: illustration of a substrate cross section of a polymer ferroelectric memory device after the top electrode metal has been etched

FIG. 6: illustration of a substrate cross section of a polymer ferroelectric memory device after the photoresist removal process of an embodiment

FIG. 7: illustration of a photoresist removal tool and the nitrogen purge of an embodiment

FIG. 8: illustration of a photoresist removal tool an the low pressure chemical spray of an embodiment

FIG. 9: illustration of a photoresist removal tool and the high pressure chemical spray of an embodiment

FIG. 10: illustration of a high pressure chemical spray arm motion of an embodiment

FIG. 11: illustration of a high pressure chemical spray arm motion of an embodiment with a cone-shaped spray

FIG. 12: illustration of a high pressure chemical spray arm motion of an embodiment with a fan-shaped spray

FIG. 13: illustration of a photoresist removal tool and another low pressure spray of an embodiment

### DETAILED DESCRIPTION

Embodiments of a method of removing photoresist are described. Reference will now be made in detail to a description of these embodiments as illustrated in the drawings. While the embodiments will be described in connection with these drawings, there is no intent to limit them to drawings disclosed herein. On the contrary, the intent is to cover all alternatives, modifications, and equivalents within the spirit and scope of the described embodiments as defined by the accompanying claims.

Simply stated, an embodiment of the invention is a method of removing photoresist. More specifically, an embodiment is a method of removing photoresist utilized to pattern the top electrode metal layer in a polymer memory device substantially without damaging the underlying polymer by utilizing a low pressure photoresist solvent spray, a high pressure photoresist solvent spray, and/or a combination thereof.

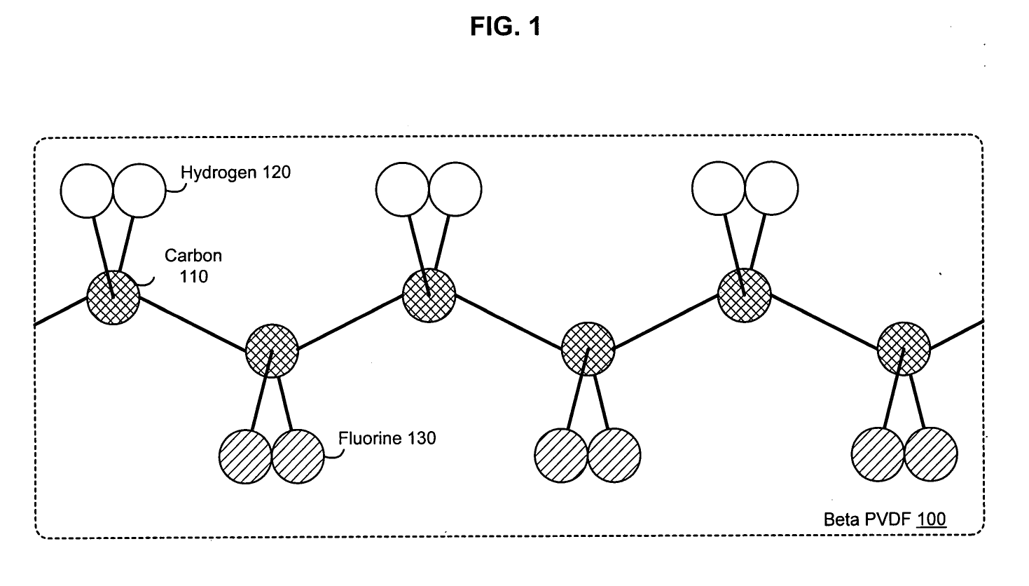

As noted, a large portion of the historical research in ferroelectric memory device technology has centered on select crystalline materials such as PZT and SBT. More current trends, however, include utilizing polymer chains that exhibit ferroelectric properties. Polyvinylidene Fluoride (“PVDF”) is a fluoropolymer with alternating CH₂ and CF₂ groups for which the relative electron densities between the hydrogen and fluorine atoms create a net ionic dipole moment. FIG. 1 illustrates the ferroelectric beta phase PVDF 100, including a chain of carbon 110 and alternating and opposing hydrogen 120 and fluorine 130 pairs. A particular PVDF copolymer is polyvinylidene fluoride trifluoroethylene (“PVDF-TrFE”). The addition of the trifluoroethylene C₂HF₃ (essentially substituting a hydrogen with a fluorine) in the chain reduces the overall theoretical ionic dipole moment of a ferroelectric PVDF beta phase chain, but increases the likelihood of forming the ferroelectric PVDF beta phase versus the paraelectric PVDF alpha phase during crystallization. The crystalline PVDF-TrFE polymer is ferroelectric in that it can be given a remanent polarization that can be switched in a sufficiently high electric field (i.e., a coercive field). The polarization can be used to store a binary “0” state and a binary “1” state of a memory device fabricated therewith based on the orientation of the polarization.

Memory elements utilizing polymer ferroelectric materials can be passive in the sense that there is no need for active components (e.g., a transistor coupled to a MOS capacitor in DRAM). Data is stored by changing the polarization of the polymer chain between metal lines that sandwich the layer comprised of the ferroelectric polymer. The elements are driven externally by applying a voltage to the appropriate word and bit lines to read or write to a polymer ferroelectric memory cell. Configured as such, the read cycle is destructive and the memory cell must be rewritten akin to a DRAM refresh cycle.

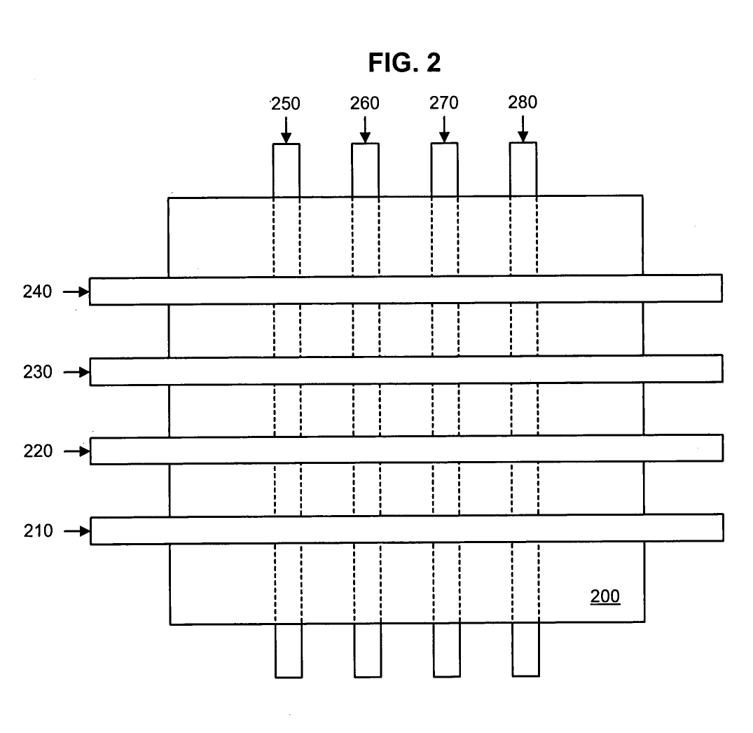

FIG. 2 illustrates a top view of a single layer polymer ferromagnetic memory device. Bit lines 250-280 and word lines 210-240 sandwich a layer of polymer ferroelectric material 200. When a voltage is applied across overlapping bit and word lines (e.g., bit line 250 and word line 240) a number of operational processes are possible. A relatively high voltage (e.g., ranging approximately between 8 and 10 volts), can create a coercive electric field sufficient to program a binary “1” state or a binary “0” state based on altering the orientation of the remanent polarization of the polymer ferroelectric material 200 sandwiched between the bit and word lines 250 and 240 respectively. A separate voltage can be applied, in conjunction with external detection circuitry not illustrated, to read the binary state of the memory cell.

There are a variety of processing challenges associated with fabricating polymer ferroelectric memory devices. One challenge is to deposit and pattern materials adjacent to the ferroelectric polymer layer as the ferroelectric polymer is susceptible to damage by certain processing steps common to, for example, photoresist removal. Further, the photoresist removal that is compatible with the ferroelectric polymer must simultaneously not damage (e.g., by etching) exposed metal.

As is well known in the art, photoresist is a photosensitive organic polymer utilized in the photolithographic process. Once the photoresist has been used to pattern for example an etch, deposition, or implant process step as is well known in the art, it is removed and the exposed substrate is cleaned in preparation for subsequent process steps. Photoresist removal (also called photoresist strip, or PR strip) can occur by a variety of different mechanisms and combinations thereof. For example, the photoresist may be removed with a solvent, and may further be subject to sonic energy while being exposed to the solvent. The photoresist may also be removed by ashing whereby the substrate is exposed to an oxygen-containing plasma that thermally decomposes the photoresist. The ashing may be followed by a solvent or rinse process step to remove any remaining photoresist or photoresist ash.

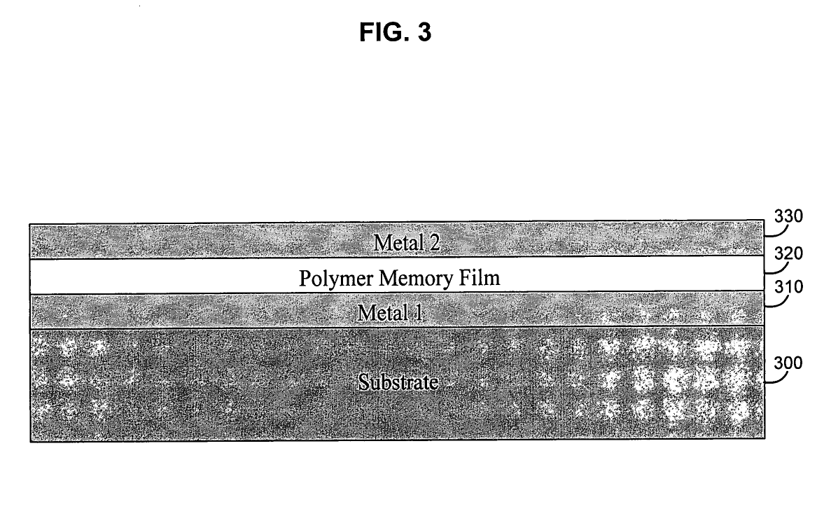

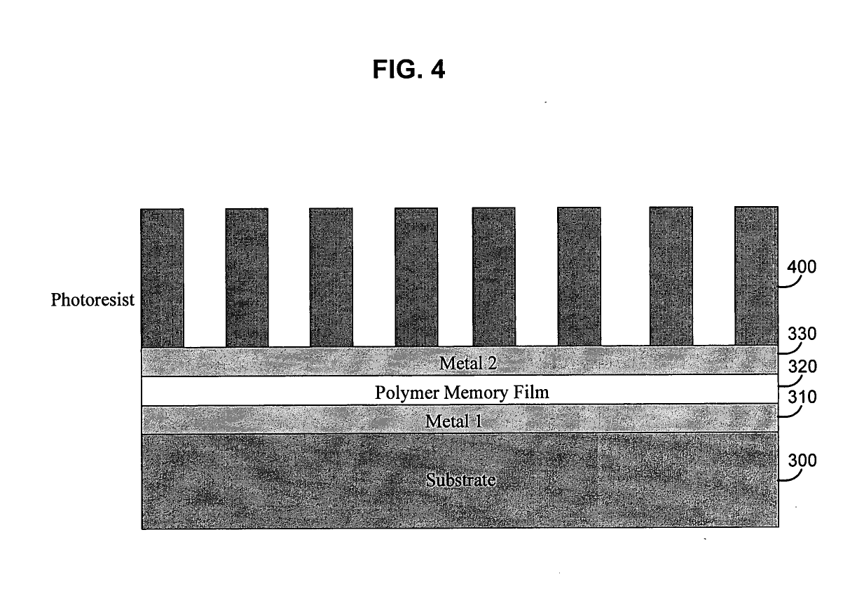

FIGS. 3 through 6 depict substrate cross sections to illustrate metal layer patterning processing steps associated with a metal electrode of a polymer memory device. A substrate 300 onto which the polymer ferroelectric memory is fabricated can be any substrate onto which it would be useful to fabricate a memory device, ranging from, for example, a bulk silicon wafer to the top interconnect, dielectric, or passivation layer of a dual damascene process architecture. Metal 310 is the bottom electrode of the polymer memory and forms, for example, one of word lines 210-240 word line illustrated by FIG. 2. Metal 310 can be any metal suitable as electrode material in a polymer memory device. For example, metal 310 may be titanium, titanium oxide, titanium nitride, aluminum, tantalum, gold, silver, tungsten, ruthenium, rhodium, palladium, platinum, cobalt, nickel, iron, copper, or alloys thereof. A polymer layer 320 is deposited atop the metal 310 layer. In an embodiment, the polymer layer 320 is polyvinylidene fluoride. In another embodiment, the polymer layer 320 is a copolymer of polyvinylidene fluoride and trifluoroethylene. The addition of the trifluoroethylene reduces the overall theoretical electrical dipole of the PVDF molecule chain, but increases the likelihood that the PVDF molecule will orient in its ferroelectric beta phase. Metal 330 is the basis for the top electrode of the polymer memory that will form, for example and following the processes of FIGS. 4 through 6, bit lines 250-280. Metal 330 can be any metal suitable as electrode material in a polymer memory device. For example, metal 330 may be titanium, titanium oxide, titanium nitride, aluminum, tantalum, gold, silver, tungsten, ruthenium, rhodium, palladium, platinum, cobalt, nickel, iron, copper, or alloys thereof.

FIG. 4 illustrates the substrate 300 of FIG. 3 following the deposition and patterning of photoresist layer 400. Though not illustrated, photoresist layer 400 is, for example, spin-coat deposited as a blanket layer on top of the metal 330 blanket layer to be patterned. Using well known photolithographic techniques, the photoresist is patterned to expose select areas of the metal 330 layer.

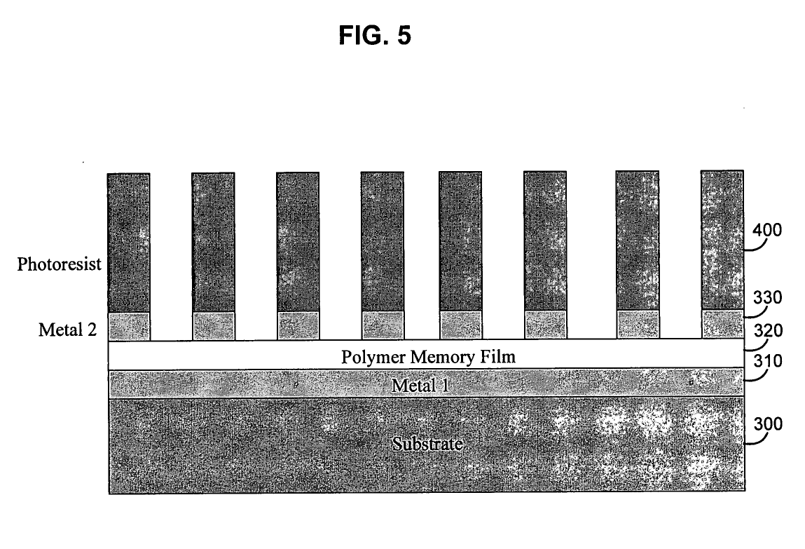

FIG. 5 illustrates the substrate 300 of FIG. 4 following the removal of select portions of the metal 330 layer to fabricate, for example, bit lines 250-280. As introduced, metal 330 may be titanium, titanium oxide, titanium nitride, aluminum, tantalum, gold, silver, tungsten, ruthenium, rhodium, palladium, platinum, cobalt, nickel, iron, copper, or alloys thereof. In an embodiment, the metal is removed with a reactive ion etch with BCl₃, Cl₂, argon, helium, or combinations thereof. After portions of the metal 330 layer have been removed, portions of the polymer layer 320 are exposed.

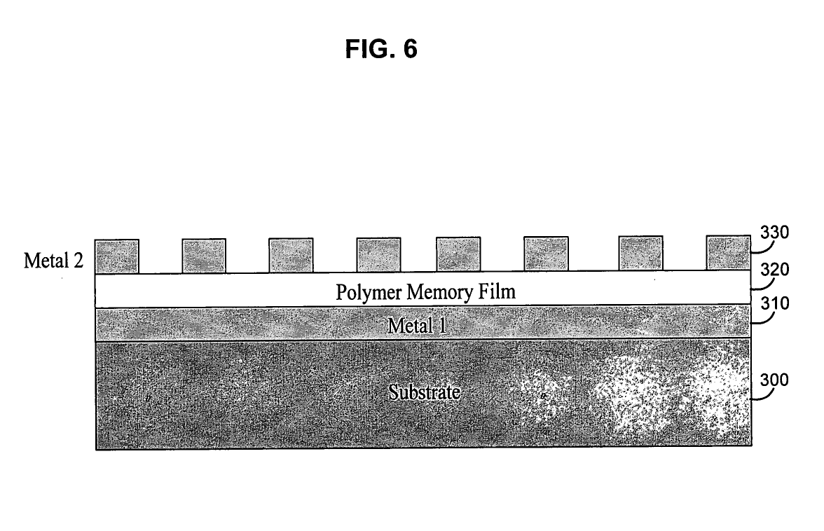

FIG. 6 illustrates the substrate 300 of FIG. 5 following the removal of photoresist layer 400. As noted, there are a variety of methods common to photoresist removal including ashing and/or solvent strip as introduced above. However, traditional methods of photoresist removal are not fully compatible with the polymer layer 320. For example, given that the photoresist and polymer layer are organic polymers, solvents useful to remove photoresist may also damage the polymer layer. Similarly, ashing the photoresist with an oxygen-containing plasma may also cause damage to the polymer layer. A method of an embodiment removes photoresist 400 in the presence of exposed ferroelectric polymer 320 substantially without damaging the ferroelectric polymer 320 and substantially without damaging metal 330 by adding mechanical energy to a wet photoresist removal chemistry. During the photoresist 400 removal, the polymer 320 is not exposed to oxygen-containing plasma that may damage the polymer 320.

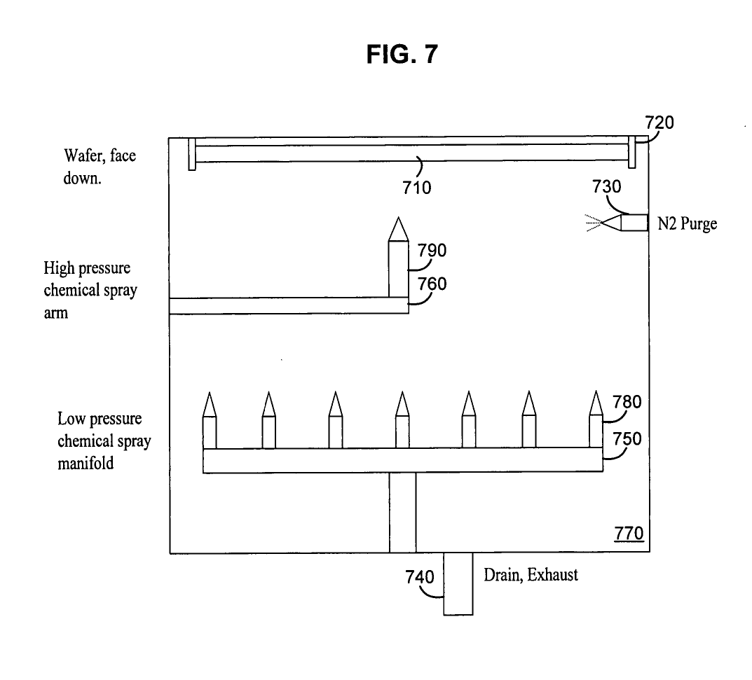

FIG. 7 illustrates a cross section of a photoresist removal tool 700. Inside a chamber 770, the photoresist removal tool includes a fixture 720 to hold a wafer 710 in place during the photoresist removal process. As used herein, wafer 710 includes or is the substrate on which the polymer memory is fabricated. In an embodiment, the wafer 710 is oriented such that the face of the wafer 710 (i.e., the side of the wafer including the fabricated circuit elements) is facing down and toward the source of a solvent spray that is sprayed up toward the wafer 710 surface. Further, in an embodiment, the fixture 720 is configured to spin the wafer 710.

Once the wafer 710 is secure in the fixture 720, the ambient within the chamber 770 is purged with, for example, nitrogen to evacuate substantially all of the oxygen in the chamber. In an embodiment, and as will be discussed more fully below, the wet photoresist removal chemistry may include, for example, metal corrosion inhibitors that degrade if oxidized. The nitrogen purge reduces that oxidizing exposure.

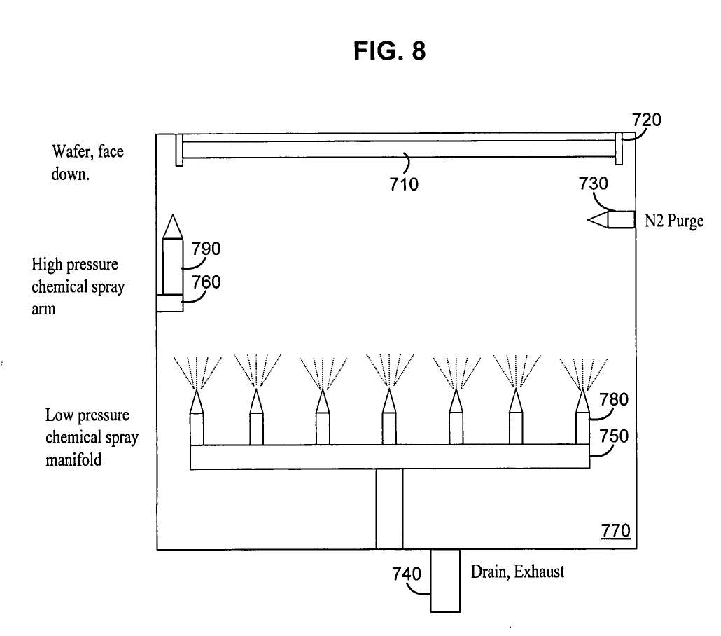

Once the chamber 770 is purged with, for example, nitrogen, the low pressure chemical spray manifold 750, including a plurality of low pressure nozzles 780, sprays the surface of the wafer 710 with a wet photoresist removal chemistry as illustrated by FIG. 8. In an embodiment the wafer 710 is spinning in the fixture 720 to aid uniformity in wet photoresist removal chemistry coverage. The pressure of the wet photoresist removal chemistry is approximately between 10 and 100 pounds per square inch. In an embodiment, the wet photoresist removal chemistry pressure is approximately 90 pounds per square inch. The wet photoresist removal chemistry has a temperature of approximately between 20° C. and 90° C. In an embodiment, the wet photoresist removal chemistry temperature is approximately 70° C. The low pressure chemical spray manifold 750 sprays the wafer 710 with the aforementioned parameters for approximately between 10 and 200 seconds. In an embodiment the low pressure chemical spray manifold 750 sprays the wafer 710 for approximately 90 seconds. During the spray, the wafer 710 may be spun in the fixture 720 at approximately between 25 and 1500 revolutions per minute. In an embodiment, the wafer is spun in the fixture 720 at approximately 50 revolutions per minute. During the low pressure spray of an embodiment, a high pressure chemical spray arm 760 is withdrawn, swung aside, or otherwise moved so as to not interfere with the spray from the low pressure chemical spray manifold 750.

Generally speaking, the wet photoresist removal chemistry is a glycol ether based solution that, among other constituents, may contain water and a metal etch inhibitor so as to mitigate damage to metal 330 during the photoresist 400 removal. In an embodiment, photoresist 400 is T.O.K. 601B. In an embodiment, the wet photoresist removal chemistry is ASHLAND EZSTRIP 100, ARCH MS5010, or SHIPLEY XP-0215. Though an embodiment described herein utilizes the same wet photoresist removal chemistry (i.e., solvent), it is to be understood that each of the first low pressure, high pressure, and second low pressure sprays may utilize different solvents.

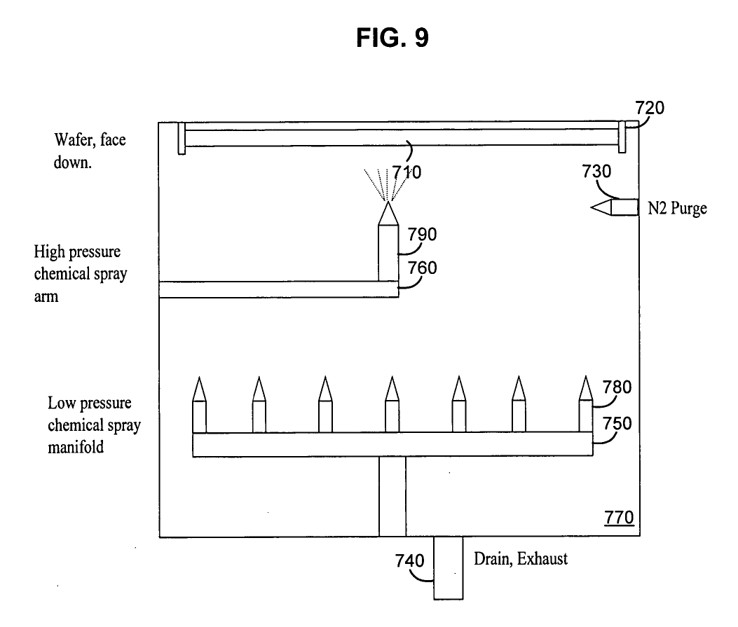

FIG. 9 illustrates the high pressure chemical spray of an embodiment. After the wafer 710 has been sprayed by the low pressure chemical spray manifold 750, the high pressure chemical spray arm 760, including a high pressure nozzle 790, extends, swings or otherwise positions underneath the wafer 710. The high pressure nozzle then sprays the face of the wafer 710 with a wet photoresist removal chemistry. The pressure of the wet photoresist removal chemistry is approximately between 100 and 500 pounds per square inch. In an embodiment, the wet photoresist removal chemistry pressure is approximately 400 pounds per square inch. The wet photoresist removal chemistry has a temperature of approximately between 20° C. and 90° C. In an embodiment, the wet photoresist removal chemistry temperature is approximately 70° C. The high pressure nozzle 790 sprays the wafer 710 with the aforementioned parameters for approximately between 10 and 1000 seconds. In an embodiment, the high pressure nozzle 790 sprays the wafer 710 for 300 seconds. During the spray, the wafer 710 may be spun in the fixture 720 at approximately between 25 and 1500 revolutions per minute. In an embodiment, the wafer is spun in the fixture 720 at approximately 50 revolutions per minute.

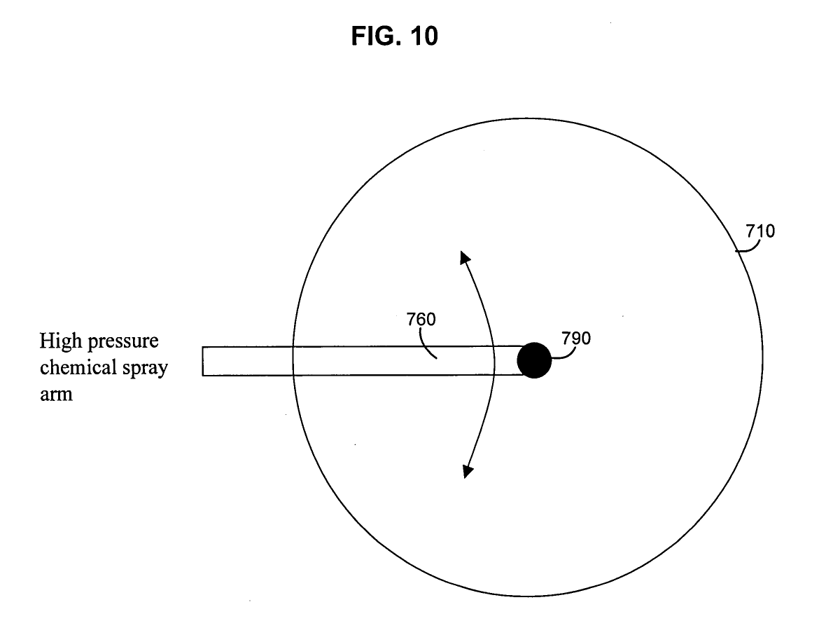

FIG. 10 illustrates a bottom view of the wafer 710 and the high pressure chemical spray arm 760 including the high pressure nozzle 790. During the high pressure spray, the high pressure chemical spray arm 760 is rotated about, for example, a pivot so that the high pressure nozzle 790 sweeps an arc across the surface of the wafer 710. In an embodiment, the wafer 710 is spinning in the fixture 720 while the high pressure nozzle 790 is swept back and forth in an arc across the surface of the wafer 710. The combination of sweeping the high pressure nozzle 790 and spinning the wafer 710 improves the uniformity with which the surface of the wafer 710 is exposed to the wet photoresist removal chemistry.

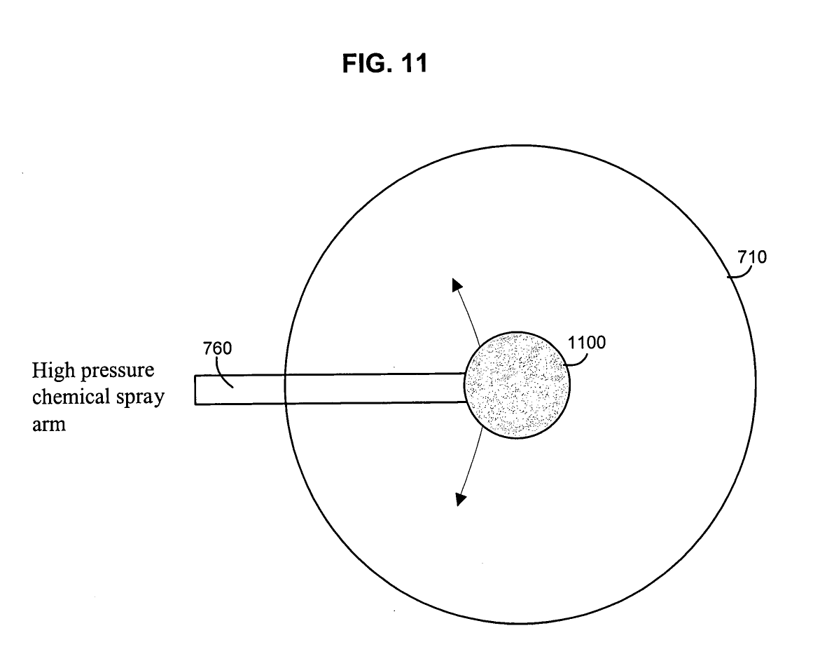

The shape of the wet photoresist removal chemistry spray emitting from the high pressure spray nozzle 790 can be altered to adjust the coverage of the wafer. For example, the high pressure spray nozzle 790 may spray the wet photoresist removal chemistry substantially in a cone shape as illustrated by FIG. 11 and cone-shaped spray 1100. The angle of the cone vertex may be altered to control the shape of the cone. Further, the distance between the high pressure spray nozzle 790 and the wafer 710 may be altered to control the surface area covered by the spray for a given cone vertex angle created by the high pressure spray nozzle 790.

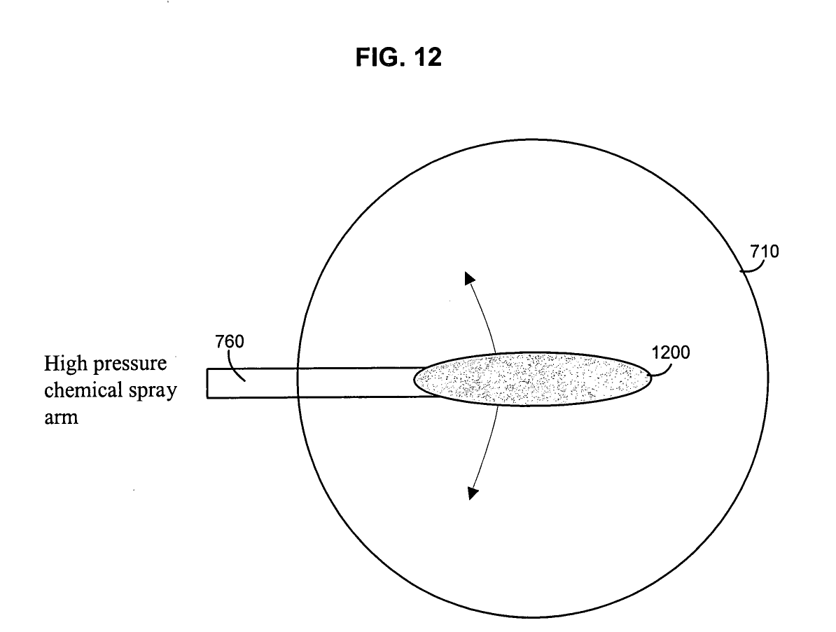

FIG. 12 illustrates a fan-shaped spray 1200 of an embodiment. The fan-shaped spray 1200 of an embodiment operates in conjunction with the high pressure chemical spray arm 760 rotated about, for example, a pivot so that the high pressure nozzle 790 sweeps an arc across the surface of the wafer 710 to uniformly expose the surface of the wafer 710 to the wet photoresist removal chemistry. As with the cone-shaped spray 1100, the vertex angle of the fan-shaped spray 1200 and/or the distance between the wafer 710 and the high pressure spray nozzle 790 may be adjusted to control the surface area covered by the fan-shaped spray 1200 of an embodiment.

The effectiveness of the photoresist layer 400 removal depends in significant part on the addition of mechanical energy to the wet photoresist etch chemistry. As noted, adding sonic energy has been one approach utilized to encourage the solvent removal of photoresist. For example, the sonic energy may be in the form of ultrasonic (i.e., greater than 20,000 hertz) vibration as the, for example, wafer 710 including a photoresist layer 400 is submerged in a photoresist solvent. However, it is difficult to apply sonic energy uniformly to the substrate as it is difficult to tune or focus the sonic energy evenly over the entire surface of the substrate. Further, sonic energy is directional. The same sonic energy directionality that promotes photoresist removal, however, tends to also shear the underlying ferroelectric polymer. Further, the entire substrate is exposed to the sonic energy, potentially damaging otherwise interior layers.

The solvent spray or sprays of an embodiment, in addition to exposing the photoresist layer 400 to a solvent, adds mechanical energy to the solvent substantially perpendicularly to the surface of wafer 710. The spray parameters (e.g., pressure, nozzle size and configuration, solvent type, solvent temperature, and duration of spray), in combination with the motion of both the wafer 710 and, if applicable, the motion of the high pressure chemical spray arm 760 can be adjusted to substantially uniformly expose the surface of the wafer 710 to the wet photoresist removal chemistry. Further, the same parameters, or a subset thereof, can be adjusted to increase or decrease the mechanical energy experienced by the surface of the wafer 710 to remove the photoresist layer 400 substantially without damaging the underlying polymer layer 320.

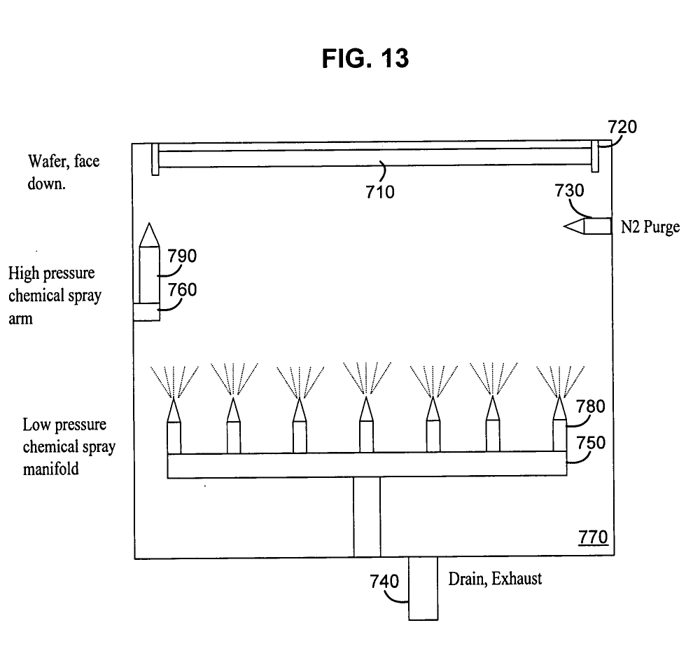

Once the wafer 710 has been exposed to the high pressure spray, the low pressure chemical spray manifold 750, including a plurality of low pressure nozzles 780, sprays the surface of the wafer 710 with the wet photoresist removal chemistry as illustrated by FIG. 13. In an embodiment the wafer 710 is spinning in the fixture 720 to aid uniformity in wet photoresist removal chemistry coverage. The pressure of the wet photoresist removal chemistry is approximately between 10 and 100 pounds per square inch. In an embodiment, the wet photoresist removal chemistry pressure is approximately 90 pounds per square inch. The wet photoresist removal chemistry has a temperature of approximately between 20° C. and 90° C. In an embodiment, the wet photoresist removal chemistry temperature is approximately 70° C. The low pressure chemical spray manifold 750 sprays the wafer 710 with the aforementioned parameters for approximately between 10 and 200 seconds. In an embodiment the low pressure chemical spray manifold 750 sprays the wafer 710 for approximately 90 seconds. During the spray, the wafer 710 may be spun in the fixture 720 at approximately between 25 and 1500 revolutions per minute. In an embodiment, the wafer is spun in the fixture 720 at approximately 50 revolutions per minute. During the low pressure spray of an embodiment, a high pressure chemical spray arm 760 is withdrawn, swung aside, or otherwise moved so as to not interfere with the spray from the low pressure chemical spray manifold 750. The second low pressure spray substantially removes any remaining photoresist 400 from the wafer 710. In an embodiment, the second low pressure spray may be omitted as substantially all of the photoresist 400 is removed by the first low pressure spray and the high pressure spray.

Following photoresist 400 removal, the wafer 710 may be rinsed with, for example, deionized water to remove the wet photoresist removal chemistry from the surface of the wafer 710. In an embodiment, the deionized water rinse is preceded by a rinse with ethylene glycol to prevent a reactive solvent from interacting with the water to the extent that the solvent, for example, precipitates solute or leaves a residue on the wafer 710 surface. The wafer 710 may further be spun dry. In an embodiment, the wafer 710 is spun for approximately 180 seconds at approximately 1500 revolutions per minute. In an embodiment, the rinse and spin-dry is performed by photoresist removal tool 700 so as to avoid transferring or transporting a wet wafer. During the spin-dry, the chamber 770 may be opened to the ambient atmosphere (i.e., dry air) to facilitate drying.

As noted, the resulting rinsed and dried wafer 710 has had the photoresist 400 removed in the presence of exposed ferroelectric polymer 320. An embodiment removes the photoresist 400 without substantially damaging the ferroelectric polymer 320 as the ferroelectric polymer 320 is neither exposed to a damaging solvent nor exposed to an oxygen-containing plasma during the photoresist 400 removal. Further, the metal 330 has not been substantially damaged by exposure to the solvent. In an embodiment, the result is a substantially intact layer of ferroelectric polymer 320 combined with a substantially intact layer of metal 330 that has been patterned to form, for example, bit lines 250-280.

It is to be understood that the wafer may be spun in the fixture either clockwise or counter clockwise relative to a reference direction. For example, in an embodiment the wafer is spun in one direction for the first low pressure spray and the high pressure spray and in the other direction for the second low pressure spray. However, the spin orientation may be altered differently. Altering the spin direction may aid the uniformity with which the wet photoresist removal chemistry removes photoresist 400. For example, it may be that spinning the wafer 710 in the same direction for all sprays creates a leeward side to the photoresist 400 topology and non-uniform photoresist 400 removal.

One skilled in the art will recognize the elegance of the disclosed embodiment in that it mitigates one of the limiting factors of fabricating polymer ferroelectric memory devices. By avoiding ashing (i.e. exposure to oxygen-containing plasma) photoresist removal steps, an embodiment substantially avoids damaging the ferroelectric polymer during photolithographic patterning steps during which the ferroelectric polymer is exposed.

What is claimed is:

1. A method comprising:
spraying a solvent on a substrate with a high pressure spray wherein the substrate includes a layer of photoresist and exposed ferroelectric polymer of a polymer ferroelectric memory device.

2. The method of claim 1 further comprising:
spraying the solvent on the substrate with a low pressure spray.

3. The method of claim 1 further comprising:
rotating the wafer during the high pressure spraying.

4. The method of claim 3, rotating the wafer further comprising:
rotating the wafer approximately between 25 and 1500 revolutions per minute.

5. The method of claim 4, rotating the wafer further comprising:
rotating the wafer at approximately 50 revolutions per minute.

6. The method of claim 1 wherein the solvent has a temperature approximately between 20° C. and 90° C.

7. The method of claim 6 wherein the solvent has a temperature of approximately 70° C.

8. The method of claim 1 wherein the solvent has a pressure of approximately between 100 and 500 pounds per square inch.

9. The method of claim 8 wherein the solvent has a pressure of approximately 400 pounds per square inch.

10. The method of claim 1 wherein the high pressure spray has a duration of approximately between 10 and 1000 seconds.

11. The method of claim 10 wherein the high pressure spray has a duration of approximately 300 seconds.

12. The method of claim 1 wherein the solvent is selected from the group consisting of a glycol ether based solvent, ASHLAND EZSTRIP 100, ARCH MS5010, and SHIPLEY XP-0215.

13. The method of claim 1 wherein the photoresist comprises T.O.K. 601B photoresist.

14. The method of claim 1 wherein the high pressure spray is substantially cone-shaped.

15. The method of claim 1 wherein the high pressure spray is substantially fan-shaped.

16. The method of claim 1 further comprising:
pivoting a high pressure spray nozzle across the surface of the wafer to substantially completely expose the surface of the wafer to the high pressure spray.

17. A method comprising:
spraying a solvent on a substrate with a first low pressure spray wherein the substrate includes a layer of photoresist and exposed ferroelectric polymer of a polymer ferroelectric memory device;
spraying the solvent on the substrate with a high pressure spray after the first low pressure spray.

18. The method of claim 17 further comprising:
spraying the solvent on the substrate with a second low pressure spray after the high pressure spray.

19. The method of claim 18 further comprising rotating the wafer during the first low pressure spray, the high pressure spray, and the second low pressure spray.

20. The method of claim 19, rotating the wafer further comprising rotating the wafer approximately between 25 and 1500 revolutions per minute during the first low pressure spray.

21. The method of claim 20, rotating the wafer further comprising rotating the wafer at approximately 50 revolutions per minute during the first low pressure spray.

22. The method of claim 19, rotating the wafer further comprising rotating the wafer approximately between 25 and 1500 revolutions per minute during the high pressure spray.

23. The method of claim 22, rotating the wafer further comprising rotating the wafer at approximately 50 revolutions per minute during the high pressure spray.

24. The method of claim 19, rotating the wafer further comprising rotating the wafer approximately between 25 and 1500 revolutions per minute during the second low pressure spray.

25. The method of claim 24, rotating the wafer further comprising rotating the wafer at approximately 50 revolutions per minute during the second low pressure spray.

26. The method of claim 19 wherein one of the first low pressure spray, high pressure spray, and second low pressure has a rotation direction different than another of the first low pressure spray, high pressure spray, and second low pressure spray.

27. The method of claim 18 wherein the solvent has a temperature approximately between 20° C. and 90° C.

28. The method of claim 27 wherein the solvent has a temperature of approximately 70° C.

29. The method of claim 18 wherein the solvent has a pressure of approximately between 10 and 100 pounds per square inch for the first low pressure spray.

30. The method of claim 29 wherein the solvent has a pressure of approximately 90 pounds per square inch for the first low pressure spray.

31. The method of claim 18 wherein the solvent has a pressure of approximately between 100 and 500 pounds per square inch for the high pressure spray.

32. The method of claim 31 wherein the solvent has a pressure of approximately 400 pounds per square inch for the high pressure spray.

33. The method of claim 18 wherein the solvent has a pressure of approximately between 10 and 100 pounds per square inch for the second low pressure spray.

34. The method of claim 33 wherein the solvent has a pressure of approximately 90 pounds per square inch for the second low pressure spray.

35. The method of claim 18 wherein the first low pressure spray has a duration of approximately between 10 and 200 seconds.

36. The method of claim 35 wherein the first low pressure spray has a duration of approximately 90 seconds.

37. The method of claim 18 wherein the high pressure spray has a duration of approximately between 10 and 1000 seconds.

38. The method of claim 37 wherein the high pressure spray has a duration of approximately 300 seconds.

39. The method of claim 18 wherein the second low pressure spray has a duration of approximately between 10 and 200 seconds.

40. The method of claim 35 wherein the second low pressure spray has a duration of approximately 90 seconds.

41. The method of claim 18 wherein the solvent is selected from the group consisting of a glycol ether based solvent, ASHLAND EZSTRIP 100, ARCH MS5010, and SHIPLEY XP-0215.

42. The method of claim 18 wherein the photoresist comprises T.O.K. 601B photoresist.

43. The method of claim 18 wherein the high pressure spray is substantially cone-shaped.

44. The method of claim 18 wherein the high pressure spray is substantially fan-shaped.

45. The method of claim 18 further comprising pivoting a high pressure spray nozzle across the surface of the wafer to substantially completely expose the surface of the wafer to the high pressure spray.

46. A method comprising:
removing a photoresist layer from a substrate including an exposed ferroelectric polymer and an exposed metal, each of a polymer ferroelectric memory device, with a high pressure solvent spray wherein the exposed ferroelectric polymer and the exposed metal are substantially undamaged by the high pressure solvent spray.

47. The method of claim 46 wherein the ferroelectric polymer comprises polyvinylidene fluoride.

48. The method of claim 46 wherein the ferroelectric polymer comprises a copolymer of polyvinylidene fluoride and trifluoroethylene.

49. The method of claim 46 wherein the solvent comprises a glycol ether based solvent.

50. The method of claim 46 wherein the pressure of the high pressure solvent spray is approximately between 100 and 500 pounds per square inch.

51. The method of claim 50 wherein the pressure of the high pressure solvent spray is approximately 400 pounds per square inch.
